(19) United States
(12) Patent Application Publication
(10) Pub. No.: US 2004/0014430 A1
(43) Pub. Date: Jan. 22, 2004

(54) Multiple antenna system for wireless communication

(76) Inventor: Raviv Melamed, Street Nes Ziona (IL)

Correspondence Address: Mark Friedman, Bill Polkinghorn, Discovery Dispatch, 9003 Florin Way, Upper Marlboro, MD, 20772, US

(21) Appl. No.: 10/362,795

(22) PCT Filed: Jul. 11, 2001
(86) PCT No.: PCT/US01/21795

(51) Int. Cl. H04B 1/38

(52) U.S. Cl. 455/73; 455/426.2

(57) ABSTRACT

In a wireless communication system (200) having a transceiver comprising a transmitter and a receiver, a multiple antenna system comprises two receive antennas (224,226) connected with a spatial distribution topology to reduce multi-path, and third transmit antenna (228) connected to the transmitter. The wireless communication system may be a wireless local loop (WLL), or a wireless local area network (WLAN). The wireless communication system may suitably operate at frequencies from 2.4 GHz, including in the 5 GHz band.

### TECHNICAL FIELD OF THE INVENTION

The invention relates to wireless communication systems and, more particularly to s antenna arrays for transceivers in Wireless Local Loop (WLL) applications.

### BACKGROUND OF THE INVENTION

Over recent years, the market for wireless communications has enjoyed tremendous growth. Wireless technology now reaches or is capable of reaching virtually every location on the face of the earth. Hundreds of millions of people exchange information every day using pagers, cellular telephones, and other wireless communication products.

A Wireless Local Loop (WLL), sometimes referred to as radio-in-the-loop (RITL) or fixed-radio access (FRA), is a system that connects subscribers to the public switched telephone network (PSTN) using radio signals as a substitute for copper for all or part of the connection between the subscriber and the switch. This includes cordless access systems, proprietary fixed radio access, and fixed cellular systems.

In conventional wired systems, the local loop refers to the connection that runs from the subscriber's telephone set, PBX or telephone system to the telephone company's central office (CO). As the name implies, a Wireless Local Loop (WLL) connects potential users to the CO by substituting a wireless base station for the local-loop connection.

WLL service is a viable alternative for part of the world that can leapfrog expensive and time-consuming wire installations in establishing modern telecommunications systems.

In any communication system utilizing wireless radio frequency (RF) transmission of signals, one should take into account the effects of “multi-path” signal propogation. Multi-path occurs when copies of the desired signal arrive at the receiving antenna after bouncing from objects between the signal source and the receiving antenna A typical multi-path problem is “dropout”, which is caused by multi-path phase canellations (multi-path nulls). A signal which has taken an indirect path from transmitter to receiver will be out-of-phase with a signal which has taken an direct path to the receiver.

Multi-path conditions which can cause dropouts are very common indoors, since the output of a wireless transmitter radiates in all directions and bounces off many types of surfaces in a foom. In reality, a wireless system operating in a room will be generating perhaps hundreds of reflections around the room, but the system continues to operate since the direct path signal is normally the strongest of all the signals. Metal is an especially good reflector, so multi-path conditions can also occur outdoors, since the transmitter signal can be efficiently reflected from cars, trucks, trailers, metal building surfaces, etc.

A known way of confronting the multi-path problem is “space diversity” wherein two (or more) antennas are used. Generally, the two antennas are connected to a switch, and the system decides at which of the two antenna the signal level is higher, and switches to it. The antennas are physically spaced apart from one another (spatially diverse) to combat signal fading and improve signal quality. The desired spacing depends on the degree of multi-path angle spread, but should be at least one half wavelength of the operating frequency to ensure that the antennas are receiving uncorrelated (“diverse”) signals to gain the full benefit of diversity reception.

Another application for wireless communication systems is the wireless (W) Local Area Networks (LAN). A WLAN is a data transmission system designed to provide location-independent network access between computing devices by using radio waves rather than a cable infrastructure. In the corporate enterprise, WLANs are usually implemented as the final link between the existing wired network and a group of client computers, giving these users wireless access to, the full resources and services of the corporate network across a building or campus setting.

The 5 GigaHertz (GHz) band has become the new frontier for high bandwidth WLAN products. Being spectrally clean and wide, the 5 GHz band attracts much attention as being the enabler of wide public acceptance for broadband WLAN products.

FIG. 1 illustrates a typical transceiver of a wireless communication system 100, comprising the following major components, connected as shown:

an amplifier 102;

an up converter 104;

an automatic gain control (AGC) 106;

a power amplifier 108;

a transmit/receive (T/R) switch 110;

an amplifier 112;

an down converter 114;

an automatic gain control (AGC) 116;

a low noise amplifier 118;

a phase lock loop 120; and

a voltage-controlled oscillator (VCO) 122.

The system 100 is shown in a configuration where a signal to be transmitted is supplied as an input intermediate frequency (IF) signal from a modem (not shown), and the received signal is provided as an output IF signal to the modem. The transmitter portion of the transceiver comprises the amplifier 102, the up converter 104, the automatic gain control (AGC) 106 and the power amplifier 108. The receiver portion of the transceiver comprises the amplifier 112, the down converter 114, the automatic gain control (AGC) 116, and the low noise amplifier 118.

Typically, transmission will occur on a different (e.g., higher) frequency than reception, and a reference signal (“Reference Signal”) is provided to the PLL 120, which controls the VCO 122. The output of the VCO 122 is provided to both of the up and down converters 104 and 114, respectively.

The T/R switch 110 comprises two switches 110a and 110b; each serving a different purpose. The switch 110a is. for switching between transmit and receive. The switch 110b is for selecting between two antennas 124 and 126. As illustrated in FIG. 1, the output of the power amplifier 108 is provided through the T/R switch 110 to an antenna 124. With the switch 110b in the other position (not shown), the output of the power, amplifier 108 would be provided to the antenna 126. This is when the transceiver is in a transmit mode of operation. In a receive mode, the switch 110a would be in the other position (not shown) so that a signal received by a selected one of the two antennas 124 and 126 (as determined by the position of the switch 110b), would be provided to the input of the low noise amplifier 118. The switch 110a selects between the transmit and receive modes, and the switch 110b selects between the two antennas, in either mode.

The reason for having two antennas 124 and 126 is generally for providing space diversity to confront the multi-path problem, as described above. A suitable mechanism for determining which of the two antennas to use (in other words, the position of the switch 110b) is well known, and can simply be a comparator which determines which antenna is receiving the strongest signal and causing the switch 110b to switch to that antenna, as described hereinabove.

The system 100 may use Time Division Multiple Access (TDMA) or Time Division Duplex (TDD). Time Division Multiple Access (TDMA) is a method used in wireless technology to separate multiple conversations over set frequencies and bandwidth. In TDMA, the frequency band is split into a number of channels which in turn are stacked into short time units so that several calls can share a single channel without interfering with one another. Time Division Duplex (TDD) is a method of multiplexing transmit/receive (uplink/downlink) parts of a wireless communications link together, wherein the exchange of uplink: and downlink information takes place on the same frequency, but is distinguished by time-slot characteristics.

In a wireless communication system such as has been shown and described with respect to FIG. 1, the switches 110a and 110b typically will each cause an attenuation of 1-1.5 (deciBel) dB, resulting in a total attenuation of 2-3 dB for the T/R switch 110. This degrades the performance of the system. The degradation results in a poor noise figure for the receiver, and lower (power) efficiency for the transmitter.

### SUMMARY OF THE INVENTION

It is therefore an overall object of the invention to provide an improved wireless communication system.

It is another object of the invention to provide a wireless communication system which has a better noise figure for the receiver and a better power efficiency for the transmitter.

According to the invention, in a wireless communication system having a transceiver comprising a transmitter and a receiver, a multiple antenna system comprises two receive antennas connected by a switch to the receiver; and a third, transmit antenna connected to the transmitter. The wireless communication system may be a wireless local loop (WLL), or a wireless local area network (WLAN). The wireless communication system may suitably operate at frequencies from 2.4 GHz up to 40 GHz, including in the 5 GHz band.

According to the invention, in a wireless communication system having a transceiver comprising a transmitter and a receiver, two antennas and spatial distribution are used for receiving signals, and a third antenna is used for transmitting signals. This method improves the noise figure for the receiver, and improves the power efficiency of the transmitter.

Other objects, features and advantages of the invention will become apparent in light of the following description thereof.

### BRIEF DESCRIPTION OF THE DRAWING

Reference will be made in detail to preferred embodiments of the invention, examples of which may be illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

The structure, operation, and advantages of the present preferred embodiment of the invention will become further apparent upon consideration of the following description, taken in conjunction with the accompanying figures, wherein:

FIG. 1 is a block diagram of a transceiver with two antennas, according-to the prior art; and

FIG. 2 is a block diagram of a transceiver with three antennas, according to the invention.

### DETAILED DESCRIPTION OF THE INVENTION

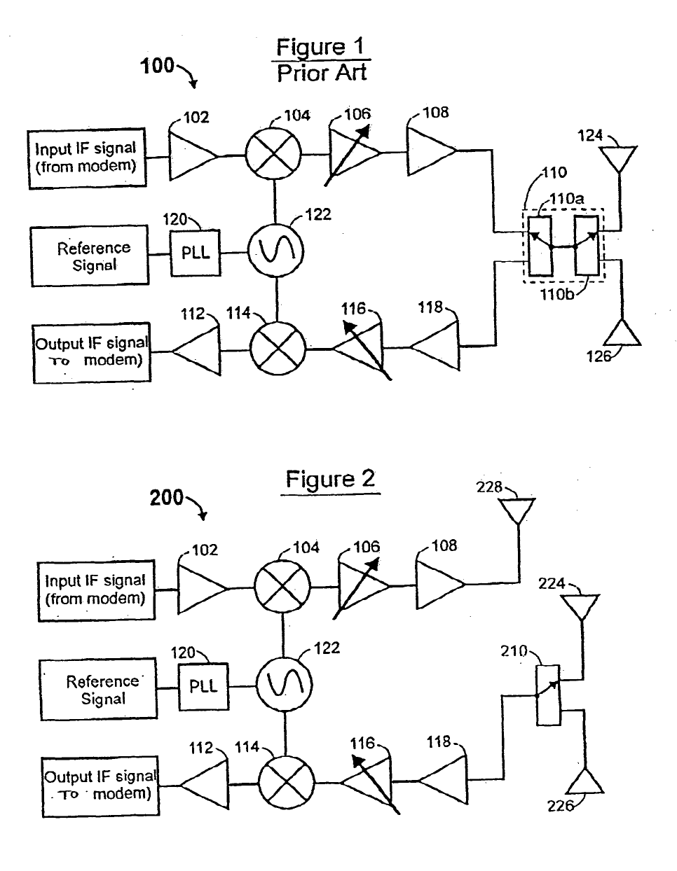

FIG. 2 illustrates a typical transceiver portion of a wireless communication system 200, comprising the following major components, which may be identical to those of the wireless communication system 100 of FIG. 1 connected as shown:

an amplifier 102;

an up converter 104;

an automatic gain control (AGC) 106;

a power amplifier 108;

an amplifier 112;

an down converter 114;

an automatic gain control (AGC) 116;

a low noise amplifier 118;

a phase lock loop 120; and

a voltage-controlled oscillator (VCO) 122.

A switch 210, comparable to and performing a function similar to the switch 110b, is provided for selectively switching two antennas 224 and 226 (compare 124 and 126) to the input of the low noise amplifier 118 of the receiver portion of the transceiver, in order to overcome the multi-path problem, as described hereinabove.

Conspicuous by its absence is a transmit/receive (T/R) switch (110)—more particularly, a switch (compare 110a) for switching an antenna between the transmitter and the receiver portions of the transceiver. Rather, a third antenna 228 is provided, and is dedicated solely to the transmitter of the transceiver. The output of the power amplifier 108 is provided directly to the “transmit” antenna 228, and therefore need not pass through two switches (110a, 110b), resulting in improved power efficiency for the transmitter. Additionally, a received signal need only traverse one switch 210, rather than two switches (110a, 110b), resulting in an improved noise figure for the receiver.

Therefore, since the transmitter is connected directly (rather than through one or more switches) to the transmit antenna, 2-3 dB of power are saved. And, since there is also one less (one, instead of two) switch at the receiving channel, the noise figure improves in 1-1.5 dB. Altogether, for the transceiver, the gain is approximately 3-4.5 db from using this arrangement (topology) of three antennas (one transmit antenna and two receive antennas).

Although the invention has been described with respect to a limited number of embodiments, it will be appreciated that many variations, modifications and other applications of the invention may be made, and are intended to be within the scope of the invention, as disclosed herein.

What is claimed is:

1. In a wireless communication system having a transceiver comprising a transmitter and a receiver, a multiple antenna system comprising:
two receive antennas connected by a switch to the receiver; and
a third, transmit antenna connected directly to the transmitter.

2. An antenna system, according to claim 1, wherein:
the wireless communication system is a wireless local loop (WLL).

3. An antenna system, according to claim. 1, wherein:
the wireless communication system is a wireless local area network (WLAN).

4. An antenna system, according to claim 1, wherein:
the wireless communication system operates at frequencies from 2.4 GHz up to 40 GHz.

5. An antenna system, according to claim 1, wherein:
the wireless communication system operates in the 5 GHz band.

6. A method of reducing the multi-path problem in a wireless communication system, comprising:
using two antennas and spatial distribution for receiving signals; and
using a third, dedicated antenna for transmitting signals.

7. A method of improving noise figure of a receiver of a transceiver of a wireless communication system, comprising:
using two antennas and spatial distribution for receiving signals; and
using a third, dedicated antenna for transmitting signals.

8. A method of increasing power efficiency of a transmitter of a transceiver of a wireless communication system, comprising:
using two antennas and spatial distribution for receiving signals; and
using a third, dedicated antenna for transmitting signals.
